(19) United States
(12) Patent Application Publication
(10) Pub. No.: US 2002/0122181 A1
(43) Pub. Date: Sep. 5, 2002

(54) Interferometric measuring arrangement for superimposing at least two lightwaves

(75) Inventors: Peter Koch, Lubeck (DE); Christian Scholz, Norderstedt (DE); Ralf Engelhardt, Lubeck (DE)

Correspondence Address: COHEN, PONTANI,, LIEBERMAN & PAVANE, Suite 1210, 551 Fifth Avenue, New York, NY, 10176, US

(73) Assignee: Medizinisches Laserzentrum Lubeck GmbH

(21) Appl. No.: 09/910,125

(22) Filed: Jul. 20, 2001

(30) Foreign Application Priority Data
Jul. 21, 2000 (DE) 100 35 835.7

(51) Int. Cl. G01B 9/02

(52) U.S. Cl. 356/477; 356/482

(57) ABSTRACT

It is the case of an interferometric measuring arrangement for superimposing at least two light waves, with a first coupling means for coupling the light waves coming from a light source into a sample arm and into a reference arm, and with a second coupling means for superimposing the light waves coming from the reference arm and the sample arm, which are led to at least one detector. The light waves at least within the reference arm are exclusively led in at least one fiber guide which they do not leave on their path between the coupling means, and with which the sample arm extends on both sides of the first coupling means.

### BACKGROUND OF THE INVENTION

The invention relates to an interferometric measuring arrangement according to the features specified in the indtroductory part of claim 1.

Such measuring arrangements are applied in various technical fields. With this, the light emitted from a light source is divided into a sample arm and a reference arm, wherein the light waves of both arms are again joined together and led to a detection means, in order then to measure the interferences then possibly resulting.

With this one basically distinguishes between two interferometer types, specifically the fiber interferometer with which the light waves are led in fiber guides, and those with which the light waves are led freely in space. The latter have been shown to be successful in the trial construction, but however in course environmental conditions have their limitations since they are susceptible to external influences. To this extent fiber interferomters are more favourable, in which the light waves are mainly led in fiber guides, which quasi may be constructed in a system closed per se.

With the fiber interferometers the Michelson interferometer has asserted itself as a standard, with which the light waves emitted from a light source are led to a coupling means in which these on the one hand are led to a reference arm and on the other hand to a sample arm. The light waves led back in these two arms again get to the coupling means and on the one hand back to the light source and on the other hand to a detector, where the signal recording and convertion into an electrical signal is effected.

Apart from the Michelson interferometer the Mach-Zehnder interferometer is also widespread. Such is the device known from DE 691 15 477 T2. The interferometer used here leads the light waves coming from the light source to a first coupling means in which the light waves are introduced into a sample arm and a reference arm. Within the sample arm there is provided a beam splitter which lead further a part of the light waves directly to a second coupling means in which the light waves led further superimpose with those of the reference arm and are led to detection devices. This arrangement corresponds to a Mach-Zehnder interferometer as is common in fiber-optic measuring technology. This arrangement serves exclusively for measuring the path distance of the light waves which have run through the sample arm between the coupling means. The light waves which via the beam splitter reach the sample and by this are reflected, are in the sample arm are led back to the first coupling means and here led separately to a detector. The further evaluation of the recorded signals is then effected electronically in a relatively complicated manner.

Common to all fiber interferometers is the comparatively poor efficiency since maximally 50% of the light fed into the sytem by the light source reaches the detector. In practice this value is even significantly smaller since feed and other losses occur. If, which is for example usual in optical coherence tomography, the interferometric measuring arrangement is widened by a phase modulator, the losses become even greater since the mirror arrangements usually used here always have refletion losses and furthermore the mirror arrangements, in particular the movable parts, are not exactly adjustable such that also losses arise with the coupling-back.

### BRIEF SUMMARY OF THE INVENTION

Against this background it is the object of the present invention to so design an interferometric measuring arrangement of the known type such that the efficiency is increased. Furthermore there is to be created a powerful and simply constructed interferometric measuring arrangement which in particular is also to comprise a phase modulator in order for example to be applied in optical coherence tomography.

The object of the invention is achieved by the features specificed in claim 1. Advantageous formations of the invention are given in the the dependent claims as well as the subsequent description.

A considerable advantage of the measuring arrangement according to the invention is that 50% of the light waves coupled in the first coupling means and coming from the light source directly reach into the reference arm and leave this without a direction reversal, i.e. into the second coupling means. The remaining 50% of the lightwaves produced by the light source which reach into the sample arm are by way of direction reversal led through the first coupling means and from here via a fiber guide to the second coupling means. With this arrangement up to 75% of the light waves fed into the arrangement by the light source reach the detector means. The measuring arrangement is thus extremely strong in light and furthermore extremely robust since the light waves may to the greatest extent be led in fiber guides which lead these almost without losses and uninfluenced by environmental influences.

The detector means comprises preferably two detectors which are provided on the output side of the coupling means. The arrangement of two detectors is in particular advantageous with measuring arrangements since on account of the the phase jump known to arise in the coupling means the light waves led to the detectors are phase shifted so that with a suitable connecting of the detectors, when specifically the eletrical signals of the detectors are additively conjoined, there arises a signal representing the interference.

Also the sample arm may be completely formed by fiber guides when the free end of the sample arm is formed reflective on the end side. Then in the whole measuring arrangement there is effected a leading of the fiber guides, which on the one hand is particularly low in losses and on the other hand renders the measuring arrangement largely insensitive to external influences. Such an arrangement may for example be used for measuring purposes when the one part of the sample arm is already wound up as is described in U.S. Pat. No. 5,5029,978, U.S. Pat. No. 5,101,449 or U.S. Pat. No. 5,493,623. The free part of the sample arm may for example be cast with a rod whose length change is to be evaluated. Many varied measuring arrangements of this type are conceivable. With this the interferometric measuring arrangement is practically hermeticallly sealed when specifically the reference arm and sample arm consist of fiber guides which in the region of the coupling means are connected to further fiber guides as is known generally with coupling means of this type.

One advantageous further formation of the measuring arrangement according to the invention is given such that in the reference and/or sample arm there is integrated a device for changing the running path of a light wave, with which the light waves are likewise exclusively led in a fiber guide, for example as described in the previously mentioned U.S. patents. Preferably the fiber guides in each case are wound onto a divided core, wherein the distance of the core parts to one another is statically changed for example by way of an adjusting screw, or dynamically, for example by way of a piezoelectric drive and thus a directed length change of the fiber guides is achieved. In this manner the measuring arrangement may be provided with a phase modulator in order for example to be applied in optical coherence tomography, wherein the light waves are led to the greatest extent in fiber guides, so that a measuring arrangement which is not prone to breakdown and which has a high efficiency is created. With this preferably two such devices are applied for changing the running path, and specifically one in the form of a phase modulator for dynamically changing the running path and another for setting the operating point which usefully is integrated in the reference arm.

A basic problem with such devices is the temperature sensitivity since with a changing temperature usually also the set operating point is changed. In order to prevent this or to rule out as much as possible the effects which this entails, the invention envisages connecting to one another in a heat conducting manner both devices for changing the running path, thus in the sample arm as well as in the reference arm, wherein the devices usefully are formed such that they have the same optical running paths in the fiber guides and corresponding winding numbers so that the length change in both arms caused by temperature is equal.

A operating point displacement caused by temperature is then automatically compensated by a suitable displacement in the other arm.

The invention is hereinafter described in more detail by way of one embodiment example shown in the Figures. There are shown in:

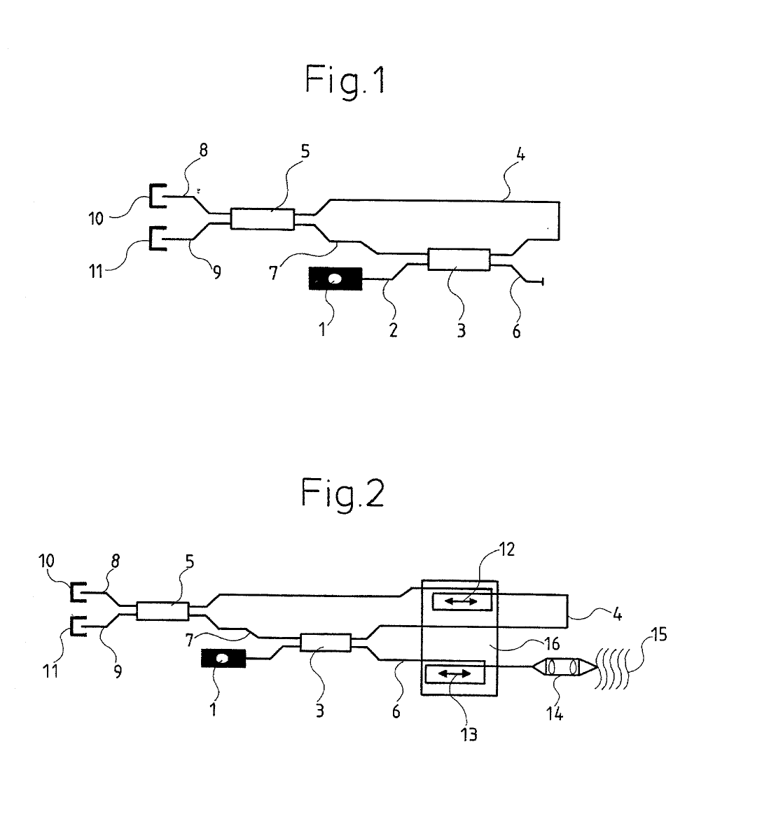

FIG. 1 in a schematic representation a first interferometric measuring arrangement according to the invention and

FIG. 2 a second interferometric measuring arrangement according to the invention.

The measuring arrangement represented by way of FIG. 1 shows an interferometer in its simplest form. A light source 1 in the form of a laser diode emits light waves into a fiber guide 2 which opens into a first copupling means 3.

The light waves exiting the light source 1 in the coupling means 3 are led to a fiber guide 4 which leads to a second coupling means 5, as well as to a fiber guide 6 which is mirrored at its free end. The fiber guide 4 forms the reference arm of the interferometer, whereas the fiber guide 6 forms the free part of the sample arm of the interferometer whose other part is formed by a fiber guide 7 which runs between the first coupling means 3 and the second coupling means 5, and specifically in the continuation of the fiber guide 4. The exit of the second coupling means 5 is connected via fiber guides 8 and 9 to detectors 10, 11 which convert the optical signals into electrical ones so that the signal evaluation may be effected by way of electronic circuits in a manner known per se.

The previously described arrangement is from the light source 1 to the detectors 10, 11 formed completely by fiber guides in the form of quartz fibers. It thus forms a closed sytem which functions largely independent of external influences since the light waves do not leave the quartz fibers within the measuring arrangement. It has an efficiency of up to 75%.

This arrangement thus has a comparatively high efficiency and by way of the guiding of the light waves exclusively in light guides is very insensitive to external influences such as dust, humidity and likewise.

With the measuring arrangement according to FIG. 2 there is integrated a phase modulator It is thus the case of an interferometric measuring arrangement, as is for example used in OCT. It differs from that previously described in that in the reference arm thus in the fiber guide 4 as well as in the sample arm, and specifically in the region of the part which forms a free end (fiber optic 6) or alternatively in the other part (fiber guide 7), there are integrated devices 12, 13 for changing the running path of the light. In contrast to the arrangement according to FIG. 1 however the free part of the sample arm is not mirrored on the end side but is coupled to an optic 14 which leads the light beams to a sample 15 at which they are reflected and get back to the sample arm through the optic 14.

The devices 12 and 13 represent any one of the arrangements of the fiber guides 4 and 6 respectively, wherein one of the devices is provided for setting the operating point and the other for the dynamic, i.e. periodic length change—it forms the actual phase modulator. The latter device is advantageously arranged in the sample branch, since the sample branch is passed through by the light waves twice (on the way towards the sample and on the return path), by which means independently of the constructional type of the device in comparison to the reference arm there always results a double path change. The devices 12 and 13 are connected to one another in a heat conducting manner, and specifically via a head conductor 16, by which means the arrangement operates essentially independently of temperature, since length changes caused by temperature are effected in both devices 12 and 13 to the same extent and thus compensate.

The devices 12 and 13 not described in detail are designed such that the fiber guides in the form of quarz fibers 4 and 6 or alternatively 7 (not shown) in each case are wound up over a divided winding core, wherein the distance of the core parts to one another is changeable, and specifically with the device 12 by way of an adjusting element, for example an adjusting screw, and with the device 13 by way of a drive, for example a piezoelement or a stack of piezoelements which periodically presses the core halves apart corresponding to the electrical activation, by which means there is effected the length change. The cores are of good heat-conducting material, e.g. aluminium, and are assembled on a common carrier plate 16 which forms the heat conducting connection.

Also with the measuring arrangement represented in FIG. 2 which with the exception of the devices for length change 12, 13 as well as the optic 14 connecting to the free end of the sample branch, is identical to that described by way of FIG. 1, which is also documented by way of the reference numerals accordingly used in FIG. 2, the light is largely led in fiber guides. In particular also in the reference arm an exit of the light waves out of the fiber guides is not provided. There is only required an exit at the free end of the optic 14 which however cannot be avoided in such a measuring arrangement with which a sample is to be examined. The optic itself may likewise be largely encapsulated so that also this measuring arrangement is extremely robust and insensitive to external influences and functions with a high optical efficiency.

LIST OF REFERENCE NUMERALS

| | |
|---|---|
| 1 | light source |
| 2 | fiber guide |
| 3 | first coupling means |
| 4 | fiber guide |
| 5 | second coupling means |
| 6 | fiber guide |
| 7 | fiber guide |
| 8 | fiber guide |
| 9 | fiber guide |
| 10 | detector |
| 11 | detector |
| 12 | device for changing the running path |
| 13 | device for changing the running path |
| 14 | optic |
| 15 | sample |
| 16 | heat conductor |

1. An interferometric measuring arrangement for superimposing at least two light waves, with a first coupling means for coupling the light waves coming from a light source into a sample arm and into a reference arm and with a second coupling means for superimposing the light waves which have run through the reference arm with the light waves which have run through the sample arm, with which the superimposed light waves are led to at least one detector and the light waves at least within the reference arm are exclusively led in at least one fiber guide which they do not leave on their path between the coupling means, and with which the sample arm extends on both sides of the first coupling means.

2. A measuring arrangement according to one of the preceding claims, wherein the sample arm exclusively comprises a fiber guide designed reflecting on the end side.

3. A measuring arrangement according to one of the preceding claims, wherein in the reference and/or sample arm there is integrated a device for changing the running path of a light wave, with which the light waves are led in a fiber guide.

4. A measuring arrangement according to one of the preceding claims, wherein in the sample arm as well as in the reference arm in each case there is integrated a device for changing the running path of a light wave, wherein both devices are connected to one another in a heat conducting manner.

5. A measuring arrangement according to one of the preceding claims, wherein a device for changing the running path of a light wave forms part of a phase modulator and the other device for changing the running path of a light wave is used for setting the operating point.
